(19) United States
(12) Patent Application Publication
(10) Pub. No.: US 2005/0211851 A1
(43) Pub. Date: Sep. 29, 2005

(54) Duct holder

(76) Inventor: Anthony Frank Caminita JR., Gretna, LA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 10/797,896

(22) Filed: Mar. 10, 2004

(51) Int. Cl. F16L 3/00

(52) U.S. Cl. 248/58

(57) ABSTRACT

A conduit holder for use when supporting air ducts and similar pipes without constricting airflow through the pipes. The holder has a top portion for receiving a portion of the conduit therein and an upright support attached to a bottom of the top portion and supporting the conduit at an elevated position in relation to a base surface. The support member may be a unitary body or telescopically extendable member. The top portion rotates 360 degrees in relation to the Support member to accommodate any direction of extension of the conduit.

### BACKGROUND OF THE INVENTION

The present invention relates to conduit supports and, more particularly, to a support or holder for supporting hollow conduits, such as air, heating ducts or pipes between adjacent joists of a building structure.

Conventionally, heating, cooling, ventilating and air conditioning systems (HVAC systems) in buildings use pipes, tubes, flexible ducts and other tubular bodies for conveying the air within the building. The tubular conduits are supported between floor or ceiling joists and normally secured in a suspended position by nylon straps or metal hangers that are placed between the joists. One problem with conventional duct supports is that the nylon straps or metal brackets have to be secured to a rafter, which in some cases is located at a relatively high level above a base surface, or floor of an attic. To reach the rafter, the worker has to climb a ladder or construct a special platform high enough to give access to the rafter. Naturally, such method of suspending the tubular conduits takes time and increases the cost of the labor involved in the construction of the building.

Another problem with the use of flexible straps is that they tend to constrict the airflow within a flexible duct. When the strap is tied to the rafter, it is estimated that about 25% of airflow may be lost due to the duct constriction.

Still another problem associated with suspending the air ducts is that a condensate tends to form in the portion of the air duct that sagged between adjacent straps. The accumulated moisture drips into the insulation, where it can cause damage or facilitate development of mold and mildew around the duct.

The present invention contemplates elimination of drawbacks associated with conventional methods and provision of a duct holder that can support the ducts or other tubular conduits from the bottom up.

### SUMMARY OF THE INVENTION

It is therefore, an object of the present invention to provide a duct holder that can be used in place of conventional conduit supports in a building.

It is another object of the present invention to provide a duct holder particularly adapted for use with air circulation systems wherein the conduits have to be supported at certain intervals along their lengths.

These and other objects of the present invention are achieved through a provision of a support device that allows the conduit to be elevated above a base surface without constricting the air flow passing through the conduit. The support device has a top portion, or main body and an upright support member rotatably engaged with the main body. The top portion defines a channel for receiving a portion of a conduit therein. The channel is sized and shaped to accommodate different shape and diameter conduit, such as for instance air ducts. The upright support can be formed as a unitary member or with telescopically extendable portions to allow positioning of the conduit at a desired height above a base surface.

The support member is provided with a plurality of openings spaced along the length of the support member. Attaching screws or bolts can be extended through the openings for securing the upright member to a structural member, such as rafters or joists.

### BRIEF DESCRIPTION OF THE DRAWINGS

Reference will not be made to the drawings, wherein like parts are designated by like numerals, and wherein FIG. 1 is a perspective view of a duct holder in accordance with the present invention.

FIG. 2 is a front view of the duct holder of the present invention.

FIG. 3 is a top view of the duct holder of the present invention.

FIG. 4 is the bottom view of the duct holder of the present invention.

FIG. 5 is side view of the duct holder of the present invention.

### DESCRPTION OF THE PREFERRED EMBODIMENT

Turning now to the drawings in more detail, numeral 10 designates the duct holder in accordance with the present invention. The duct holder 10 comprises a top main body member 12 and an upright support member 14. The main body 12 has a generally arcuate shape defining a channel 16 for receiving a tubular conduit, such as an air duct therethrough. The main body 12 has a bottom surface 18, the center of which is secured to a top portion 20 of the support member 14.

The main body 12 is preferably formed of relatively rigid durable non-corrosive material, Such as polypropylene, aluminum and other comparable material. The size and shape of the channel 16 formed by the main body 12 varies, depending on the exterior configuration of the duct to be supported by the holder 10.

The support member 14 is formed from a strong non-corrosive material capable of withstanding the weight of a section of the duct resting within the main body 12. The support member 14 has a generally U-shaped cross-section having a central wall 22 and a pair of parallel side walls 24 and 26. A plurality of spaced-apart openings 28 are formed along the length of the central wall 22, extending from the lower portion 30 to the top portion 20 of the support member 14.

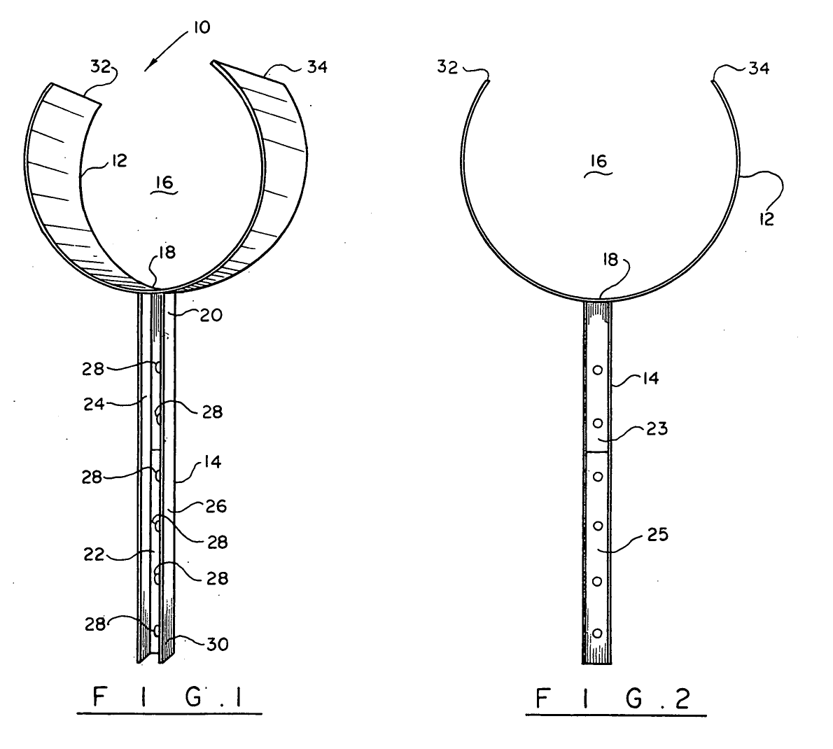

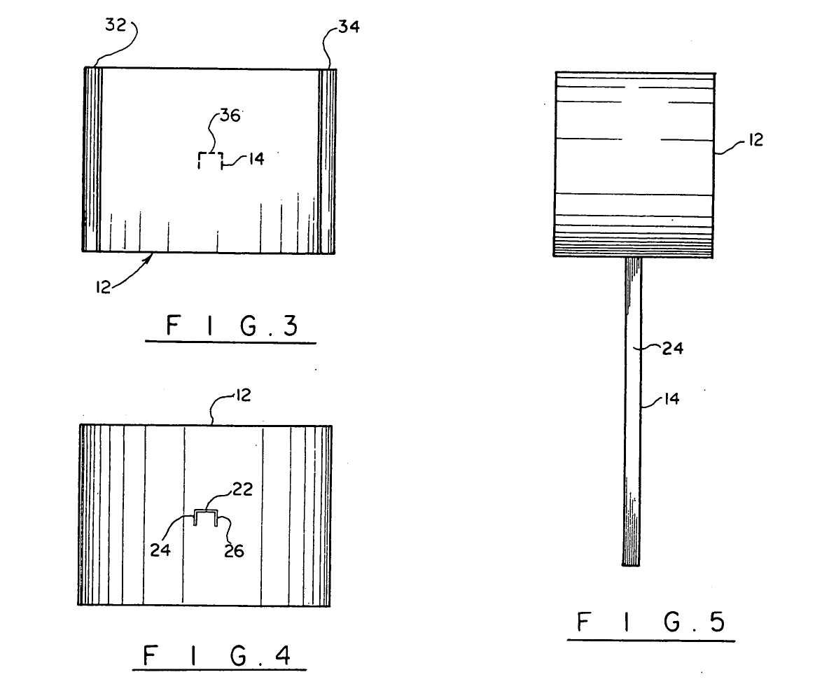

The support member 14 shown in FIGS. 1, and 3-5 is formed as a unitary body. The support member shown in FIG. 2 is formed as a telescopically extendable member having a top part 23 and a bottom part 25 that slide in relation to each to allow extension of the support member 14 to a desired length. When using a telescopic body, the support member 14 may be secured in an extended position by passing a pin or screw through a pair of aligned openings 28. The extended length of the support member allows holding of the top portion 12 and the duct supported therein at a desired elevated position in relation to a base surface, for instance an attic floor. The openings 28 are also used for attaching the support member 14 to structural members, such as rafters or joists inside the structure.

Construction regulations require that flexible or hard metal ducts be supported every 5 feet along their length and that sagging of the ducts between the supports not exceed more than 2-½ inches. The present invention allows support of the air duct from the bottom without constricting the air flow, as is often the case with nylon straps, by allowing the flexible ducts or hard metal ducts to rest within the main body 12. As a result, the loss of airflow is minimized and greater efficiency of HVAC systems may be achieved. Additionally, the collection of moisture under the ducts is eliminated since the ducts are supported in an elevated position above the floor or insulation.

The main body 12 is rotatably attached to the support member 14 by a rivet 36, allowing the channel 16 to be oriented in any desired direction where the air duct needs to be directed. The 360-degree rotation of the main body 12 in relation to the support member 14 allows the main body 12 to be oriented in an infinite number of angles in relation to the central axis of the support member 14. As result considerable flexibility in positioning of the holder 10 on any available structural member is achieved. The support member 14 is attached to a structural member by engaging the central wall 22 with screws, for instance sheet metal screws to a joist or a rafter.

The projecting ends 32 and 34 of the main body 12 extend at a sufficient distance from the bottom 18 and from each other as to not constrict the airflow through the air duct supported by the holder 10. The holder 10 when properly installed can readily support the weight of a section of the air duct, be it a flexible air duct or a hard metal conduit.

It will be understood that the particular shape of the main body 12 and the support member 14 in the embodiment shown in FIGS. 1-4 is examplary and can be easily modified depending on the requirements of the job. For instance, the main body 12 may be formed as a three-sided body forming a rectangular channel for accommodating an air duct or other conduit. The support member 14 may have an I-shaped cross-section; it may be a solid rectangle, cylinder and the like.

Many other changes and modifications may be made in the design of the present invention without departing from the spirit thereof. I therefore pray that my rights to the present invention be limited only by the scope of the appended claims.

1. A conduit holder, comprising:
a main body having a central channel extending therethrough, said channel being sized and shaped for receiving a portion of the conduit therein;
an upright support member secured to a bottom of the main body, said support member being configured for securing to a structural member.

2. The conduit holder of claim 1, wherein said support member is adapted for supporting the main body and the conduit in an elevated position.

3. The conduit holder of claim 1, wherein said main body is adapted for rotational movement in relation to the support member.

4. The conduit holder of claim 1, wherein said support member is provided with a plurality of openings to allow attaching of the support member to a structural member.

5. The conduit holder of claim 1, wherein said main body has a generally arcuate configuration to accommodate cylindrical conduits positioned therein.

6. The conduit holder of claim 1, wherein said support member has a pair of telescopically engaging parts to allow extension of the support member to a desired elevation.

7. A duct holder, comprising:
a main body having a generally U-shaped configuration and a central opening sized and shaped to accommodate a portion of the duct resting within the main body; and
an upright support member secured to a bottom of the main body, said support member being attachable to a structural member for supporting the main body and the portion of the duct in an elevated position in relation to a base surface.

8. The duct holder of claim 6, wherein said support member has an elongated body and a plurality of openings formed in the elongated body to allow attaching of the support member to structural member at a pre-determined height in relation to the base surface.

9. The duct holder of claim 6, wherein said main body is rotatably engaged with the support member.

10. The duct holder of claim 6, wherein said support member has telescopically extendable portions to allow positioning of the main body at a desired elevated level.

11. A duct holder, comprising:
a main body with a central channel defining a receiving area for a portion of a duct; and
an upright support attachable to a structural member for supporting the portion of the duct in an elevated position in relation to a base surface without constricting air flow moving through the duct.

12. The duct holder of claim 11, wherein said support member has telescopically extendable portions for adjusting elevation level of the main body in relation to the base surface.
